(19) United States
(12) Patent Application Publication
(10) Pub. No.: US 2026/0236402 A1
(43) Pub. Date: Aug. 13, 2026

(54) MACHINE LEARNING CACHE MANAGEMENT

(71) Applicant: QUALCOMM Incorporated, San Diego, CA (US)

(72) Inventors: Minsoo KIM, Seoul (KR); Kyuhong SHIM, Seoul (KR); Seunghan YANG, Incheon (KR); Juntae LEE, Seoul (KR); Jihwan BANG, Seoul (KR); Simyung CHANG, Suwon (KR)

(21) Appl. No.: 19/053,079

(22) Filed: Feb. 13, 2025

(51) Int. Cl. G06F 12/12

(52) U.S. Cl. CPC G06F 12/12

(57) ABSTRACT

Certain aspects of the present disclosure provide techniques and apparatus for machine learning. In an example method, a key tensor and a value tensor are generated for a token of an image of a sequence of images. The key tensor and the value tensor are stored in a memory, and a temporal score is generated, for the token, based on the key tensor and a set of key tensors for corresponding tokens in other images of the sequence of images. A spatial score is generated, for the token, based on a norm of the value tensor. The key tensor and the value tensor are evicted from the memory based on at least one of the temporal score or the spatial score, and an output of a generative machine learning model is generated based at least in part on key tensors and value tensors remaining in the memory.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large models (e.g., deep neural networks, large language models (LLMs), large vison models (LVMs), large multimodal models (LMMs), and the like) to process and generate output data. Often, machine learning models induce substantial computational expense in inferencing (e.g., generating model output). This expense is particularly problematic on resource-constrained devices (e.g., smartphones). Some attempts to mitigate the computational expense include caching intermediate values during inferencing for subsequent use. However, given the architectures of modern models, such caches rapidly become unacceptably large and often exceed available memory space.

### BRIEF SUMMARY

Certain aspects of the present disclosure provide a processor-implemented method, comprising: generating, for a first token of a first image of a first sequence of images used as input to a generative machine learning model, a first key tensor and a first value tensor; storing the first key tensor and the first value tensor in a memory; generating, for the first token, a first temporal score based on the first key tensor and a set of key tensors for one or more corresponding tokens in one or more other images of the first sequence of images; generating, for the first token, a first spatial score based on a norm of the first value tensor; evicting the first key tensor and the first value tensor from the memory based on at least one of the first temporal score or the first spatial score; and generating an output of the generative machine learning model based at least in part on one or more key tensors and one or more value tensors remaining in the memory.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for cache management in machine learning models, according to some aspects of the present disclosure.

FIG. 2 depicts an example workflow for efficient token eviction in machine learning models, according to some aspects of the present disclosure.

FIG. 3 depicts an example workflow for iterative cache compression, according to some aspects of the present disclosure.

FIG. 4 depicts an example workflow for temporal token scoring, according to some aspects of the present disclosure.

FIG. 5 depicts an example workflow for spatial token scoring, according to some aspects of the present disclosure.

FIG. 6 depicts an example technique for spatial and temporal cache compression, according to some aspects of the present disclosure.

FIG. 7 is a flow diagram depicting an example method for efficient cache management using spatial and temporal scoring, according to some aspects of the present disclosure.

FIG. 8 is a flow diagram depicting an example method for cache management, according to some aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for effective cache management in machine learning models are provided.

In a wide variety of machine learning model architectures, attention (e.g., self-attention) is used to generate model output. For example, many models (such as LLMs, LVMs, and the like) use transformer-based self-attention operations to process tokens of input data. As used herein, a “token” can generally correspond to any logical element of data. For example, in the case of LLMs, the tokens are generally words, phrases, characters, symbols, or portions thereof. In the case of LVMs, the tokens are often pixels or sets of pixels (e.g., patches of pixels) from input images. For example, in some vision transformers (used in many LVM models), an input images is delineated into a set of patches, and the patches are often rearranged to be processed as a sequential set of patches (e.g., a one dimensional sequence of patches, rather than a two-dimensional image of patches). The patches are ingested and processed by the model sequentially.

Generating attention scores during data processing generally includes generating a set of intermediate data for each element of the data (e.g., each token). For example, for each token, the model may compute a key tensor (also referred to in some aspects as the “keys”), a value tensor (also referred to in some aspects as the “values”), and a query tensor (also referred to in some aspects as the “queries”). In some aspects, generation of these intermediate tensors is performed by linearly projecting the token (or features generated therefrom) using sets of learned weights (e.g., multiplying the token by a set of query weights, a set of key weights, a set of value weights).

Attention is generally computed for each token with respect to one or more other tokens (e.g., other patches in the image, or tokens from a prompt or instruction) based on the respective intermediate tensors for each token. Therefore, in some aspects, intermediate data caching can be used to reduce computational expense of the model (e.g., to cache intermediate data that will be used to process subsequent data). For example, in some models, the keys and values of one or more tokens may be cached (referred to in some aspects as “key-value caching” or “KV caching”) for reuse in generating attention data for subsequent tokens and/or in generating output of the model. As used herein, a “cache” may generally refer to any memory used to store the intermediate data during processing. Similarly, “caching” data may refer to storing the data in any such memory. Further, “evicting” data from a cache may refer to removing or deleting the data from the cache, marking the corresponding memory address space as unused, overwriting the data in the cache, and the like, while “retaining” data in the cache may refer to refraining from deleting or evicting the data.

While key-value caches can significantly reduce the computational expense of generating model output, these caches grow rapidly and often become a severe memory bottleneck, particularly for devices with limited memory and/or when performing long-context generation (e.g., generating output based on a relatively large input prompt). For example, the memory consumed by the KV cache can exceed the footprint of the model itself (even for large models having millions or billions of parameters).

Some approaches to mitigate these concerns include selective caching (e.g., where a subset of the intermediate data, such as data for a subset of the tokens, is cached, and/or where a subset of the intermediate data is evicted or removed from the cache during processing). In some aspects, removing the intermediate data associated with a given token may be referred to as “evicting” the token or as “token eviction.” For example, if the key tensor and value tensor of a given token are removed from the cache, it may be said that the given token was evicted from the cache.

Some conventional approaches to token eviction evaluate attention scores (or some variant thereof) of the tokens to decide which key-value pair(s) to remove from the memory. For example, tokens having low attention scores may be evicted. However, these attention-based mechanisms are often designed for use with textual systems (e.g., in LLMs), and fail to perform adequately in vision-based models (e.g., LVMs). For example, the attention score of a given visual token varies substantially based on the query or prompt (e.g., the textual instruction provided), particularly in deep layers of the model. In implementations where the query is not known, therefore, such approaches fail to perform adequately in vision models. Similarly, vision tokens often receive substantially lower attention scores as compared to textual tokens, potentially resulting in erroneous eviction of highly important vision tokens from the cache. These concerns are particularly problematic in unbounded video processing (e.g., processing video that has no defined or fixed length or end point, and can be any duration).

For example, in a streaming implementation, the model may be tasked with continuously ingesting video frames in an unbounded manner until a query is provided. Only at this point will the model process the ingested data to generate output. For example, a user may provide an input video stream (e.g., streaming media from another device, or capturing streaming media using a local camera). During this stream, the model may be tasked with ingesting the input frames and maintaining a cache (e.g., a KV cache) to be used to answer the query when the query is received. While streaming (or after the stream), the user may provide one or more input queries or prompts (e.g., by typing or verbally speaking a natural language question), such as “what does that sign mean,” “what type of tree is that,” or “what is that object next to the car?” Upon receiving the query, the model may use the cached data to generate an output response.

This combination of unbounded input context (e.g., streaming input video with no fixed duration) and unknown query until after context ingestion (e.g., if the user does not provide their request until after the event has passed in the video) renders some conventional cache management techniques ineffective.

In some aspects of the present disclosure, token eviction from the cache may be performed based on attributes of the data that incorporate the spatial and temporal nature of the unbounded streaming input environment. For example, in some aspects, the system may generate temporal scores for each token based on the importance or uniqueness of the token across the temporal dimension (e.g., across multiple frames in the video) and/or spatial scores for each token based on the value of the token across the spatial dimension (e.g., across multiple patches in each frame). By combining these temporal and spatial evaluations, the systems described herein may make improved cache eviction decisions, allowing the system to efficiently maintain the most useful or important information, even in an unbounded and query-agnostic fashion, without excessive cache growth.

Advantageously, by formulating the eviction or retention decision for each token based on both the spatial context and the temporal context of the token, the computing system can make more effective and efficient eviction decisions for the cache, even in the absence of a known user query and in the context of an unbounded stream of input. For example, aspects of the present disclosure may result in improved performance or model accuracy by using these temporal- and spatial-based evictions, as compared to some conventional methods.

### Example Workflow for Cache Management in Machine Learning Models

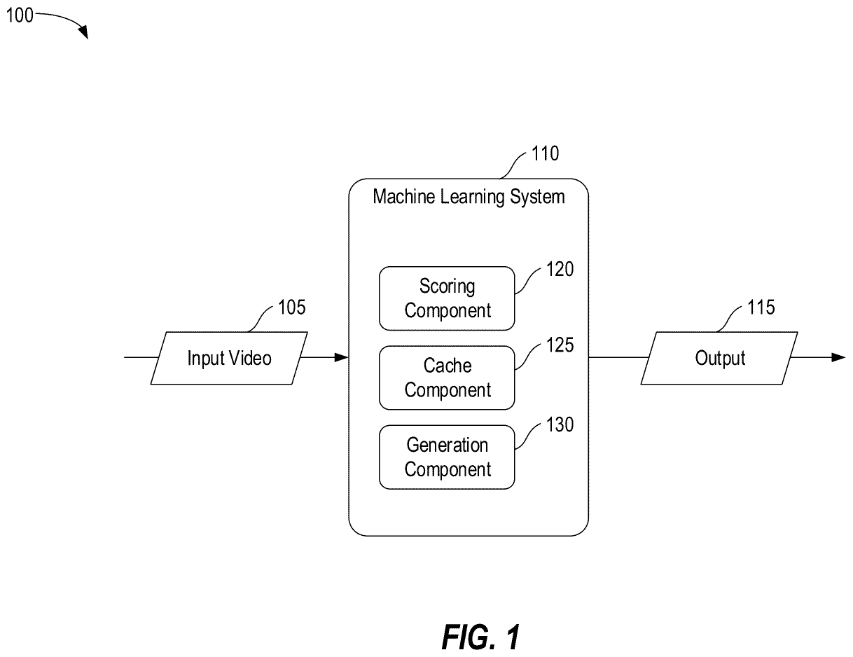

FIG. 1 depicts an example workflow 100 for cache management in machine learning models, according to some aspects of the present disclosure.

In the depicted workflow 100, a machine learning system 110 accesses an input video 105 to generate an output 115. As used herein, “accessing” data may generally include receiving, requesting, retrieving, obtaining, generating, collecting, to otherwise gaining access to the data. Although depicted as a discrete computing system for conceptual clarity, in some aspects, the operations of the machine learning system 110 may be implemented using hardware, software, or a combination of hardware and software, and may be distributed across any number and variety of systems. In some aspects, the machine learning system 110 corresponds to or is implemented on an edge device, such as a smartphone, a tablet, a wearable, or some other relatively constrained device.

In some aspects, the input video 105 generally comprises an ordered sequence of frames or images. As discussed above, in some aspects, each of the frames of the input video 105 may be delineated (by the machine learning system 110 or by another system) into an ordered sequence of patches (referred to as “tokens” in some aspects). The particular contents and format of the input video 105 may vary depending on the particular implementation. For example, in some aspects, the input video 105 may be a pre-recorded video of indeterminate (or indefinite) length (e.g., streamed from another system or device, or provided locally). In some aspects, the input video 105 may be provided as input to the machine learning system 110 in real-time (e.g., as the input video is captured). For example, a user may use a smartphone or other device to capture a video stream, processing this input video 105 in real-time as the video is captured.

Similarly, the particular content and format of the output 115 may vary depending on the particular implementation. For example, the output 115 may include a natural language textual string, an image, and the like. Although not depicted in the illustrated example, in some aspects, the machine learning system 110 may also receive a prompt or query. In some aspects, as discussed above, the query may be received after at least some of the input video 105 has been ingested (rather than being provided at the beginning of the video ingestion). For example, after streaming the input video 105 as input, the user may (while continuing to stream video, or after ending the stream) provide the input query (e.g., verbally or via writing). For example, the user may ask a question about what is or was depicted in the input video 105. In some aspects, in the absence of a specific user request, the machine learning system 110 may use a default query (e.g., “summarize the events of this video”) to generate output 115, or may refrain from generating output 115 until a query is provided.

In some aspects, the machine learning system 110 may comprise or implement one or more machine learning models (e.g., generative machine learning models such as LLMs, LVMs, LMMs, and the like). In some aspects, as part of the machine learning model operations, the machine learning system 110 may perform one or more attention operations (e.g., using transformers) to process the input data. As discussed above, attention operations (such as self-attention operations) generally use learned weight tensors to project input features (e.g., the tokens of the input video 105 or features generated therefrom) to a set of intermediate data (e.g., query (Q), key (K), and value (V) matrices). These intermediate data tensors can then be combined or evaluated to generate an attention score for each respective token (e.g., for each element of the input video 105) based on the data contained in the respective token as well as the data contained in one or more other tokens in the input video 105.

In some aspects, as discussed above, the attention of each token may be generated based at least in part on the tokens of the query (whenever the query is received). That is, the tokens of the input video 105 may be ingested and cached, as discussed below in more detail, until the query is provided. Once the query is received, the machine learning system 110 may ingest the query and generate a response based on the cached data (e.g., based at least in part on generating attention scores for the cached data based on the query).

However, as discussed above, performing this attention introduces substantial computational overhead (e.g., quadratic compute time and high memory usage). Further, in the streaming environment (where the input video 105 has no fixed length), the KV cache can rapidly grow to unmanageable levels. In the illustrated workflow 100, therefore, the machine learning system 110 can perform selective cache eviction by evicting data associated with token(s) that are predicted to have a low impact on the output 115 (e.g., based on the spatial and temporal scoring discussed in more detail below).

Specifically, in the illustrated example, the machine learning system 110 includes a scoring component 120, a cache component 125, and a generation component 130. Although not included in the illustrated example, in some aspects, the machine learning system 110 may include other components, such as to train machine learning models (e.g., to learn the values for the matrices used to generate the queries, keys, and values, among other parameters). Although depicted as discrete components for conceptual clarity, in some aspects, the operations of the depicted components (and others not illustrated) may be combined or distributed across any number of components.

In the illustrated workflow 100, the scoring component 120 may be used to generate temporal scores and/or spatial scores for tokens, as discussed above and in more detail below. For example, for each new token (e.g., for each patch in each frame of the input video 105, the scoring component 120 may generate a temporal score (based on comparing the patch to other patches in other frames of the input video 105) and/or a spatial score (based on other patches in the same frame of the input video 105).

The cache component 125 may generally be used to maintain the cache while processing data using the machine learning model. For example, in some aspects, the cache component 125 may store intermediate data (e.g., key tensors and value tensors) for tokens as the keys and values are generated (e.g., as new patches from the input video 105 are processed and ingested). In some aspects, periodically or in response to the cache becoming full, the cache component 125 may evaluate the temporal scores and/or spatial scores of each token remaining in the cache (generated by the scoring component 120), and may evict one or more tokens to maintain the size of the cache. For example, for each new token, the cache component 125 may evict the token(s) having the lowest temporal and/or spatial scores (to make room to store the keys and values of the new patch(es) while the input video 105 continues to stream in).

The generation component 130 may generally be used to generate new tokens for the output 115 of the machine learning system 110. For example, if the machine learning system 110 corresponds to or uses an LVM, the generation component 130 may generate the output tokens (e.g., words, phrases, characters, image patches, and the like) conditioned on the user-provided (or system default) query and the input video 105.

Specifically, in some aspects, the workflow 100 may begin with consumption or ingestion of the input video 105. In some aspects, the machine learning system 110 may continue to ingest the input video 105 sequentially (e.g., one frame at a time, in the order given in the input video 105). In some aspects, the machine learning system 110 may perform an iterative cache compression or eviction operation. For example in some aspects, the machine learning system 110 may ingest images (or tokens therefrom) until the cache reaches a defined size, or until a defined number of frames (or tokens) have been ingested. The machine learning system 110 may then use the spatial and/or temporal scores to evict data from the cache, and may then proceed to ingest additional frames from the input video 105.

In some aspects, this ingestion process can be repeated for all tokens in the input video 105. That is, if the input video 105 has a finite duration, the machine learning system 110 may ingest each frame. In some aspects, if the input video 105 has no defined end (e.g., the input video 105 corresponds to an ongoing video stream), the machine learning system 110 may continue to ingest the input video 105 until a query is provided (e.g., by the user). In some aspects, regardless of the duration of the video, the machine learning system 110 may interrupt ingestion if a query is received (e.g., regardless of whether the video is continuing).

After ingesting the input video 105, the cache contains data for some subset of the tokens from the input video 105. That is, while some data may be evicted from the cache during ingestion (e.g., based on the spatial and/or temporal scores), some set of the intermediate data remains in the cache. After ingesting the input video 105, the machine learning system 110 may generate the output 115 conditioned on the tokens in the cache using the forward function of the machine learning model (e.g., the LVM). Specifically, the generation component 130 may generate new tokens (e.g., image patches, words, and the like) using the generative model based in part on the intermediate data stored in the cache.

This generation process can be repeated until the generation component 130 generates an end-of-output token, until a defined (maximum) number of tokens have been generated, or until some other termination criteria are met. The output 115 (comprising a sequence of generated tokens) can then be output by the machine learning system 110 (e.g., returned to the entity or application that provided the input video 105, output via a display or speaker, and the like). In this way, the machine learning system 110 can efficiently manage relatively small cache sizes with intelligent eviction decisions based on spatial and temporal scores of the cached tokens.

For example, a user may stream the input video 105 (e.g., via a camera) into the machine learning system 110. During or after the stream, the user may input a query (such as “what type of architecture is that building?”). Upon receiving the query, the machine learning system 110 may stop ingestion of the input video 105 and may begin generating an output 115 using the query and the cached data from the input video 105 (e.g., to generate a natural language response, such as “that building appears to be neoclassic”). The machine learning system 110 may then continue to ingest the input video 105 (e.g., beginning with the first frame after the query processing began, if the video is buffered, or beginning with the next frame that is received).

Advantageously, the generation and use of spatial and temporal scores discussed herein may significantly improve performance of the machine learning system 110. In some aspects, the spatial and/or temporal based eviction can be implemented using existing generative artificial intelligence (AI) pipelines without relying on hardware modifications. Further, the disclosed techniques can be implemented as an online (e.g., runtime) algorithm that has a minimal (or at least reduced) effect on model generation latency. Additionally, as discussed above, aspects of the present disclosure enable improved performance (e.g., increased accuracy and/or reduced computational expense) for downstream tasks, particularly in limited-budget paradigms.

Moreover, certain aspects of the present disclosure can enable efficient management of the cache that allows for smaller memory footprint of the cache, allowing machine learning models (e.g., LVMs) to be deployed on devices having smaller memory capacity. Additionally or alternatively, the more intelligent cache evictions can enable accurate longer-context generation (e.g., generating output based on long or even unbounded input videos 105) using the same or less cache size, as compared to some conventional approaches.

### Example Workflow for Efficient Token Eviction in Machine Learning Models

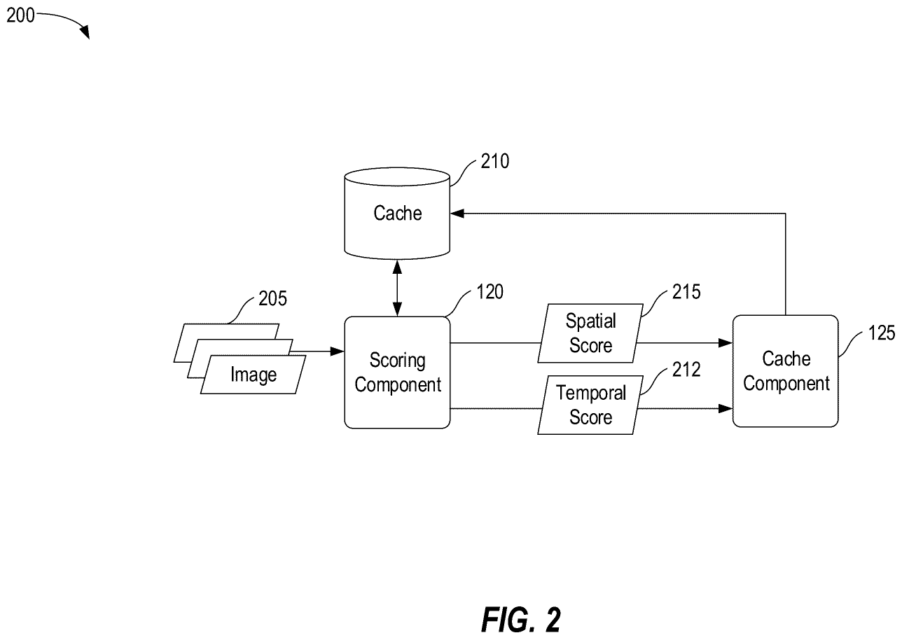

FIG. 2 depicts an example workflow 200 for efficient token eviction during data ingestion in machine learning models, according to some aspects of the present disclosure. In some aspects, the workflow 200 is performed by a machine learning system, such as the machine learning system 110 of FIG. 1.

In the illustrated workflow 200, a set (e.g., sequence) of images 205 is accessed by the scoring component 120. The images 205 may be a sequence of frames from a video (e.g., the input video 105 of FIG. 1) as discussed above. In some aspects, as discussed above, the machine learning system (or another system) may delineate each image 205 into a set of patches (e.g., tokens), and may then reorder these patches to form an ordered input sequence. In some aspects, as discussed above, the machine learning system evaluates or ingests the images 205 sequentially. That is, the prompt may comprise a sequence of images 205 with a defined order (where each image comprises a sequence of tokens or patches in a defined order), and the machine learning system may ingest the tokens in the sequential order.

As illustrated, the scoring component 120 further accesses a cache 210. The cache 210 generally includes intermediate data for one or more prior tokens. For example, as discussed above, the cache 210 may include the key tensor(s) and value tensor(s) of one or more prior token(s). That is, the cache 210 may include data for token(s) that were earlier in the sequence of tokens, relative to the next token being used as input from the images 205. In some aspects, as discussed above, the cache 210 may have a defined maximum size, such that the machine learning system periodically evicts data for token(s) as data for new token(s) is consumed.

As discussed above, the scoring component 120 generates a temporal score 212 and a spatial score 215 for each token reflected in the input images 205. For example, for each given token, the scoring component 120 may generate intermediate data including a value tensor and a key tensor for the token, caching this intermediate data in the cache 210. The scoring component 120 may further generate a temporal score 212 and a spatial score 215 indicating the predicted importance or usefulness of the given token. In some aspects, this ingestion process may proceed (token by token) until the contents of the cache 210 reach a defined size, until a defined number of tokens (or images 205) have been ingested, and the like.

As illustrated, the temporal scores 212 and the spatial scores 215 are accessed by the cache component 125, which evaluates these scores to determine whether to evict any given element of data from the cache 210. For example, as discussed above, the cache component 125 may identify the token(s) having the lowest temporal scores 212 and/or spatial scores 215, and may evict the corresponding data for these tokens from the cache 210 (e.g., removing the intermediate data, such as the key tensor and the value tensor, for the evicted token). Stated differently, the cache component 125 may select one or more tokens for retention (e.g., the tokens having the highest temporal scores 212 and/or spatial scores 215), and may evict the remaining (non-selected) tokens.

In some aspects, the cache component 125 may evaluate the spatial scores 215 and temporal scores 212 to perform cache eviction on a per-token basis (e.g., for each new token ingested, selecting one other token for eviction). In some aspects, the cache component 125 may evaluate the scores periodically (e.g., every F frames) to evict token(s), or may evaluate the scores upon determining the cache 210 has reached a desired size or fullness.

In some aspects, the cache component 125 may make eviction or retention decisions based on combining the temporal score 212 and the spatial score 215 for each token. For example, the cache component 125 may aggregate the temporal score 212 and spatial score 215 (e.g., by summing the scores, averaging the scores, and the like). The cache component 125 may then evict the token(s) having the lowest aggregated score. In some aspects, the cache component 125 may prioritize retention based on one score (e.g., the temporal score 212) before evaluating the other scores (e.g., the spatial scores 215).

For example, given a defined cache budget B (e.g., a number of tokens that should be retained in the cache after the eviction and compression process, which may be defined as a hyperparameter), the cache component 125 may first select a set of tokens for retention by identifying K tokens with the highest temporal scores 212 (e.g., where K is a defined portion of the budget B and may be defined as a hyperparameter, such as 70% of the budget). The cache component 125 may then select the remaining L tokens for retention (where L=B−K) based on the spatial scores 215 (e.g., the top-L highest spatial scores 215).

In some aspects, while selecting tokens based on the secondary score (e.g., the spatial score 215, in some aspects), the cache component 125 may refrain from “double-counting” tokens already marked for retention based on the primary score (e.g., the temporal score 212). That is, if a given token is marked for retention based on the temporal score 212, the cache component 125 may refrain from evaluating this token using the spatial score 215, in favor of retaining another token that would otherwise not be retained (e.g., a token with a high spatial score 215 but low temporal score 212).

In the illustrated workflow 200, this process is repeated for each next token in the input sequence of images 205. In some aspects, once a token is evicted from the cache 210, the machine learning system may refrain from further analyzing or processing the evicted token. That is, subsequent operations (e.g., attention operations or other machine learning operations) may be performed based on the token(s) that remain in the cache 210, and evicted tokens may be ignored or discarded.

### Example Workflow for Iterative Cache Compression

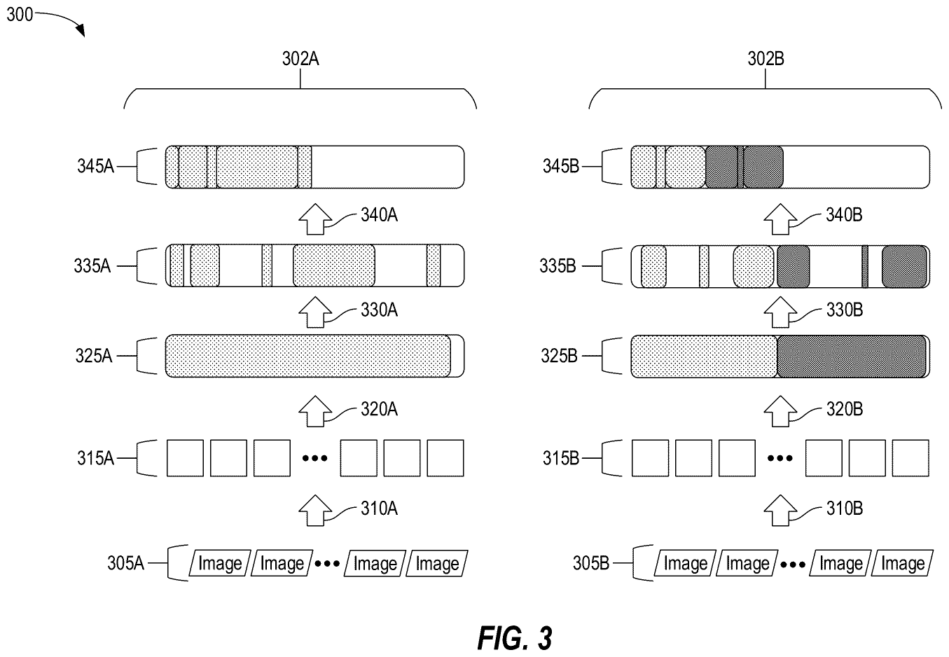

FIG. 3 depicts an example workflow 300 for iterative cache compression, according to some aspects of the present disclosure. In some aspects, the workflow 300 is performed by a machine learning system, such as the machine learning system 110 of FIG. 1.

The illustrated workflow 300 depicts iterative cache compression across two iterations, designated by a first iteration 302A and a second iteration 302B. In some aspects, each respective iteration 302 corresponds to the ingestion of a respective subset of frames (e.g., a set of images 305) from a sequence of images (e.g., from a video stream, such as the input video 105 of FIG. 1 and/or the set of images 205 of FIG. 2) to fill the memory cache (e.g., a KV cache), followed by a compression phase to reduce the size of the cache (e.g., by evicting some data). In some aspects, as discussed above, each iteration 302 may consume a defined number of images (e.g., each set of images 305 may be the same length), or may consume images until the memory cache is full (or reaches a predefined size of fullness).

In the illustrated workflow 300, during the first iteration 302A, a first set of images 305A from the sequence is ingested. As illustrated by the operation 310A, the set of images 305A is first processed to generate a set of tokens 315A. For example, as discussed above, each image in the set of images 305A may be delineated into a set of patches (where each token comprises a patch), and the patches of each image may be reordered into a one-dimensional sequence (as compared to a two-dimensional image). As a result of the operation 310A, the sequence of frames in the set of images 305A are transformed into a sequence of tokens (in the set of tokens 315A).

In the illustrated example, the operation 320A represents processing each token in the set of tokens 315A using a generative machine learning model to generate a corresponding set of intermediate data (e.g., a key tensor and a value tensor for each of the tokens), and storing the intermediate data in a memory (e.g., a cache) of the machine learning system at a time 325A. That is, at the time 325A, the cache may be relatively full of intermediate data (e.g., key and value tensors) from the set of tokens 315A. In the illustrated example, the intermediate data is indicated by stippling that fills most of the allotted memory at the time 325A.

As illustrated, after the last token in the set of tokens 315A is ingested (or after the memory at time 325A reaches a defined fullness, such as defined by the number of tokens or tensors stored, or by the size of the data stored), an operation 330A is used to sparsify the memory by evicting one or more elements of the intermediate data (e.g., the value tensors and/or key tensors corresponding to one or more tokens in the set of tokens 315A). Specifically, as illustrated at time 335A, the portions of memory having stippling correspond to intermediate data that has been retained, while the blank portions correspond to intermediate data that has been evicted.

In some aspects, in selecting which data to evict from the memory, the machine learning system can evaluate information such as a temporal score (e.g., the temporal score 212 of FIG. 2) and/or a spatial score (e.g., the spatial score 215 of FIG. 2) of each token. That is, the machine learning system may evict the intermediate data of a given token (referred to as evicting the token itself, in some aspects) if the temporal score and/or spatial score of the given token do not satisfy one or more criteria, as discussed above and in more detail below.

As discussed in more detail below, in some aspects, the temporal score of a given token indicates the uniqueness of the token with respect to other tokens at the same spatial index in one or more other frames of the set of images 305A. Further, as discussed in more detail below in some aspects, the spatial score of a given token indicates the value norm of the given token pooled with the value norms of one or more spatially adjacent tokens in the same image from the set of images 305A.

In some aspects, as discussed in more detail below, the machine learning system may first select data for retention based on selecting intermediate data corresponding to the top M tokens having the highest temporal scores (e.g., the most temporally unique tokens), followed by selecting intermediate data corresponding to the top N tokens having the highest spatial scores (e.g., the tokens having the highest pooled value norm across the spatial dimensions).

As illustrated, once the token(s) have been evicted (e.g., once the key tensors and value tensors for the non-selected tokens have been deleted, removed, or otherwise marked or flagged as deleted) from the memory, an operation 340A may be used to compress or consolidate the remaining intermediate data in the memory (as illustrated at time 345A). In some aspects, the operation 340A includes physically moving the remaining intermediate data to adjacent memory addresses in the memory, to compress the intermediate data. In some aspects, the operation 340A includes revising pointers such that the remaining data appears to be in adjacent memory spaces without actually moving the data in the memory. In some aspects, the operation 340A and resulting compressed data may be provided for illustration only, and may not actually be performed during the workflow 300. For example, the system may determine the indices of the retained data, and may then index into the cache to store the additional data (during the next ingestion iteration) at the non-retained indices (e.g., the indices of the data that was determined to be evicted from the cache).

As illustrated, after this eviction and compression cycle, the memory has more space available to ingest new data. Therefore, the second iteration 302B may be performed. In the illustrated workflow 300, during the second iteration 302B, a second set of images 305B from the sequence is ingested. As illustrated by operation 310B, the set of images 305B may be processed to generate a corresponding set of tokens 315B, as discussed above.

Operation 320B then represents processing each token in the set of tokens 315B using the generative machine learning model to generate a corresponding set of intermediate data (e.g., a key tensor and a value tensor for each of the tokens), and storing the intermediate data in a memory (e.g., a cache) of the machine learning system at a time 325B. As illustrated at the time 325B, the memory includes the intermediate data from the first iteration 302A (e.g., from the first set of images 305A) that remains from the first iteration 302A after eviction (depicted using light stippling), as well as the newly stored intermediate data (from the second set of images 305B) added during the second iteration 302B (depicted using darker stippling).

As illustrated, after the last token in the set of tokens 315B is ingested (or after the memory at the time 325B reaches a defined fullness), operation 330B is used to sparsify the memory by again evicting one or more elements of the intermediate data. Specifically, as illustrated at time 335B, the portions of memory having stippling correspond to intermediate data that has been retained, while the blank portions correspond to intermediate data that has been evicted. In the illustrated example, during the second iteration 302B, the machine learning system may evict intermediate data generated during either the current iteration 302B as well as data generated during a previous iteration (e.g., the first iteration 302A).

In some aspects, as discussed above, the machine learning system may evaluate information such as a temporal score (e.g., the temporal score 212 of FIG. 2) and/or a spatial score (e.g., the spatial score 215 of FIG. 2) of each token in the cache in order to determine which data to evict. That is, in some aspects, the memory or cache may be referred to as containing a given token if the memory or cache contains the intermediate data (e.g., key tensor and value tensor) of the token (e.g., a given token may be referred to as being stored in the cache to indicate that the token's key and/or value tensors are stored in the cache).

In some aspects, as discussed above, the machine learning system may first select data for retention based on selecting intermediate data corresponding to the top M tokens having the highest temporal scores (e.g., the most temporally unique tokens), followed by selecting intermediate data corresponding to the top N tokens having the highest spatial scores (e.g., the tokens having the highest pooled value norm across the spatial dimensions).

As illustrated, once the token(s) have been evicted (e.g., once the key tensors and value tensors for the non-selected tokens have been deleted, removed, or otherwise marked or flagged as deleted) from the memory, operation 340B may be used to compress or consolidate the remaining intermediate data in the memory (as illustrated at time 345B). In some aspects, as discussed above, the operation 340B may include physically moving the remaining intermediate data to adjacent memory addresses to compress the remaining data, and/or revising pointers such that the remaining data appears to be in adjacent memory spaces. Further, as discussed above, in some aspects the operation 340B may be optional depending on the particular implementation.

Although the illustrated example depicts two iterations 302A and 302B, the machine learning system may generally perform any number of iterations. In some aspects, such as in a streaming implementation, the machine learning system may continue to perform iterations 302 of ingesting and compressing the data in the stream until a query is received (e.g., until a request is received to generate output based on the data that has been ingested thus far).

### Example Workflow for Temporal Token Scoring

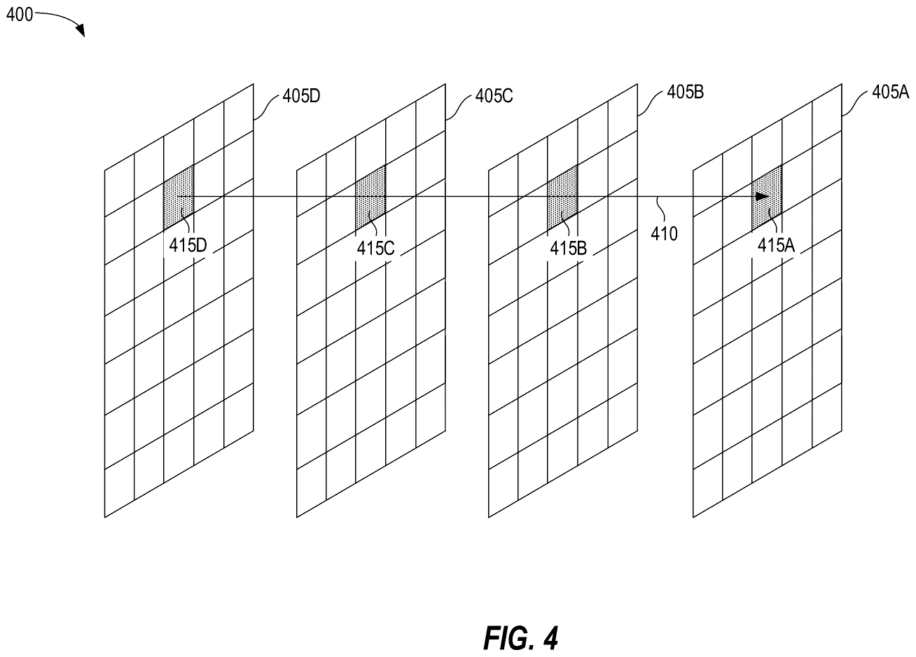

FIG. 4 depicts an example workflow 400 for temporal token scoring, according to some aspects of the present disclosure. In some aspects, the workflow 400 is performed by a machine learning system, such as the machine learning system 110 of FIG. 1.

In the illustrated example, a sequence of input images 405A-D (e.g., from the input video 105 of FIG. 1, the set of images 205 of FIG. 2, and/or the set of images 305A or 305B of FIG. 3) are depicted, where each image 405 is delineated into a set of tokens. Specifically, in the illustrated example, each image 405 is delineated into thirty-five tokens arranged in a two-dimensional matrix with five columns and seven rows. That is, the width of each image 405 may be defined as five tokens, and the height may be defined as seven tokens. In some aspects, this width and height be may be referred to as the spatial dimensions of the input stream, where the temporal dimension corresponds to the sequence of frames itself (e.g., where the image 405B is adjacent to the image 405A in the temporal dimension). Although the illustrated example depicts two-dimensional images 405, in some aspects, the images may have a depth greater than one (such as red, green, and blue (RGB) images where one depth channel includes the red data, one includes the green data, and one includes the blue data). That is, the depth dimension of each given image 405 may be distinct from the temporal dimension of the set of images 405.

In the illustrated example, as illustrated by the arrow 410, the machine learning system is generating a temporal score for the highlighted token 415A in the image 405A. In the illustrated workflow 400, the token 415A is located at spatial index (3,2) (e.g., the third column, second row). Further, as illustrated by the arrow 410, the temporal score of the token 415A is generated based on corresponding tokens 415B, 415C, and 415D, from one or more other images 405B, 405C, and 405D at the same spatial index as the token 415A.

That is, to generate the temporal score of the token 415A, the machine learning system may compare the token 415A to the corresponding tokens (at the same spatial index) in the other images 405B-D. Generally, to generate the temporal score for a given token 415, the machine learning system may evaluate any number of other images. In some aspects, the machine learning system may evaluate f prior images. That is, the machine learning system may evaluate the corresponding tokens from the set of f images that are immediately prior to the image 405A (to which the token 415A belongs) in the input sequence of images. For example for a given image, the machine learning system may compare each token in the current image to the corresponding tokens in the previous f images.

In some aspects, the machine learning system may compute a similarity score between an intermediate tensor of the given token 415A (e.g., the key tensor of the given token 415A) and the corresponding intermediate tensors (e.g., key tensors) of the corresponding tokens 415B-D in one or more prior images 405B-D. For example, the machine learning system may compute, for each prior images 405B-D, the cosine similarity between the key tensor of the token 415B and the key tensor of the corresponding token 415B-D. These cosine similarities may then be aggregated (e.g., averaged) to determine an overall temporal score of the token 415A (where less similarity indicates higher uniqueness and therefore a higher temporal score).

Although the illustrated example depicts generating a temporal score for a single token 415A based on prior images 405, in some aspects, the machine learning system may generate scores for a set of tokens. For example, the most recent r images may be designated as the “current” frames (e.g., where a set of r tokens are evaluated) and compared against the previous f-r images. Further, in some aspects, other similar operations may be used to compute the temporal score.

For example, in some aspects, given a compression window (e.g., the window of images within which the temporal score is generated) of f images, the most recent r images may be designated as the query images (where K_{query} denotes the key tensors of the query images) and the remaining f−r images may be designated as the key images (where K_{key} denotes the key tensors of the key images), and each token at spatial coordinates (i, j) is compared against corresponding tokens at the same or matching spatial coordinates. In some aspects, the machine learning system may first apply a normalization using Equations 1 and 2 below, where ∥K_{query}∥₂ is the L2 norm of K_{query}, ∥K_{key}∥₂ is the L2 norm of K_{key} and ε is a (small) constant.

$${\overline{K}}_{query} = \frac{{K}_{query}}{{‖ {K}_{query} ‖}_{2} + ϵ} \qquad ( 1 )$$

$${\overline{K}}_{key} = \frac{{K}_{key}}{{‖ {K}_{key} ‖}_{2} + ϵ} \qquad ( 2 )$$

In some aspects, the machine learning system may then compute the cosine similarity between the query and key frames using Equation 3 below, where S(i, j) is the temporal score of the token(s) at spatial index (i, j) in the query frame(s), and the negative sign ensures that lower similarity scores correspond to more distinct tokens (with higher temporal scores). That is, the temporal scores may be inversely related to the similarity scores.

$$S ( i , j ) = - \frac{1}{r} {\sum }_{t = 1}^{r} {\sum }_{{t}^{′} = 1}^{f - r} {\overline{K}}_{query}^{( t )} ( i , j ) * {\overline{K}}_{key}^{( {t}^{′} )} ( i , j ) \qquad ( 3 )$$

In some aspects, during the compression phase, the machine learning system may then determine to retain M tokens having the highest temporal scores. In some aspects, M may be a hyperparameter. For example, given a total cache budget B for the video stream, the machine learning system may determine to retain M tokens based on the temporal score (leaving B−M spaces for tokens to be retained based on the spatial scores).

In this way, the machine learning system can effectively remove temporally redundant tokens while maintaining computational efficiency.

### Example Workflow for Spatial Token Scoring

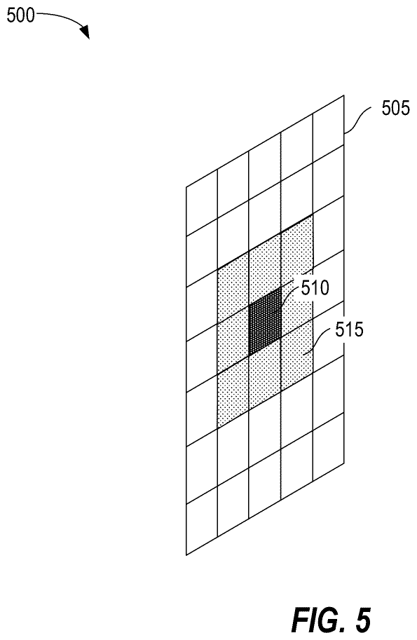

FIG. 5 depicts an example workflow 500 for spatial token scoring, according to some aspects of the present disclosure. In some aspects, the workflow 500 is performed by a machine learning system, such as the machine learning system 110 of FIG. 1.

In some aspects, while the temporal scores may be used to retain temporally unique information, the spatial score may be used to identify semantically useful information. In the illustrated, example, the machine learning system is computing a spatial score for the token 510 in the image 505. In some aspects, the machine learning system may generate a value norm for the token 510 by computing a norm (e.g., the L2 norm) of the value tensor of the token 510. That is, the value norm of the token 510 may be defined as VaN=∥V∥₂, where V is the value tensor of the token 510. Higher value norms may generally correspond to greater importance of the token 510.

In some aspects, to provide and/or enhance spatial awareness, the machine learning system may generate the spatial score of the token 510 by applying a pooling operation to aggregate the value norm of the token 510 with the value norms of one or more adjacent tokens 515. Generally, the machine learning system may use a variety of pooling operations, such as maximum pooling (e.g., where the highest value norm of the tokens in the pool is used as the spatial score of the token 510), average pooling (e.g., where the average value norm of the tokens in the pool is used as the spatial score of the token 510), sum pooling (e.g., where the sum of the value norms of the tokens in the pool is used as the spatial score of the token 510), and the like.

In the illustrated example, the pooling operation includes the tokens 515 that are immediately adjacent to the token 510 in the spatial dimensions (including diagonally). That is, in the illustrated example, the pooling operation pools value norms within a 3×3 spatial window. In some aspects, the size and/or shape of the pooling window may be defined as a hyperparameter of the model.

In some aspects, during the compression phase, the machine learning system may then determine to retain N tokens having the highest spatial scores. In some aspects, N may be a hyperparameter. For example, given a total cache budget B for the video stream, the machine learning system may determine to retain N=(B−M) tokens based on the spatial score (where M tokens are retained based on the temporal scores).

In this way, the machine learning system can effectively remove semantically and/or spatially unimportant tokens while maintaining computational efficiency.

In some aspects, as discussed above, the machine learning system may ensure that any tokens in the top M temporal scores are retained, regardless of how high (or low) the spatial scores of these tokens are.

### Example Workflow for Spatial and Temporal Cache Compression

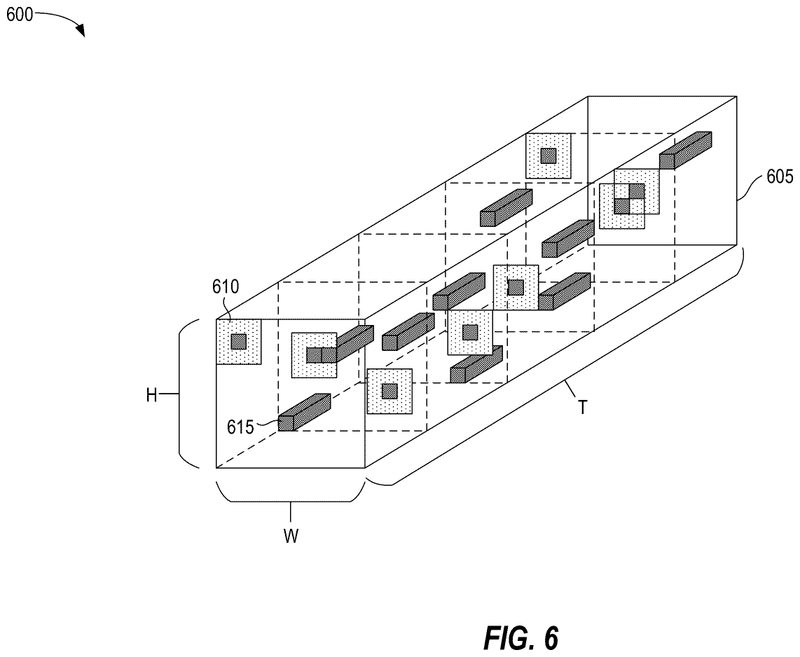

FIG. 6 depicts an example workflow 600 for spatial and temporal cache compression, according to some aspects of the present disclosure. Specifically, in some aspects, FIG. 6 depicts how data is evaluated for cache management and compression in some aspects.

In the illustrated example, input data 605 (e.g., the input video 105 of FIG. 1 and/or set of images 205 of FIG. 2) is depicted as a rectangular prism where the height (denoted H) and width (denoted W) of the input data 605 correspond to the spatial dimensions (e.g., the height and width of each image) and the depth (denoted T) corresponds to the temporal dimension (e.g., across images in the video). In the illustrated example, rather than selecting data to be retained in the cache based on information such as the attention score of each token, the machine learning system may use a combined approach that evaluates the temporal scores of each token (represented by the smaller rectangular prisms 615) as well as the spatial scores of each token (represented by the squares 610).

Specifically, as discussed above, the temporal scores of each token include evaluation of each token across the depth (e.g., across the temporal dimension T) of the input data 605. This is depicted as the depth of each rectangular prism 615 along the temporal dimension of the input data 605. Further, the spatial scores of each token include evaluation of each token across the spatial dimensions (e.g., across the height and width dimensions H and W) of the input data 605. This is depicted as the larger spatial scope of each square 610, where each square 610 has no depth.

That is, in determining which data to retain in the cache, the machine learning system may select intermediate data (e.g., key tensors and value tensors) of various tokens distributed throughout the input data 605 based on evaluating both spatial information (represented by the squares 610) as well as temporal information (represented by the rectangular prisms 615).

This allows the machine learning system to efficiently manage the memory, evicting less important information in favor of retaining intermediate data that is likely to assist in the ultimate goal (e.g., in generating a useful and accurate output based on the input query, whenever this query is provided).

### Example Method for Efficient Cache Management Using Spatial and Temporal Scoring

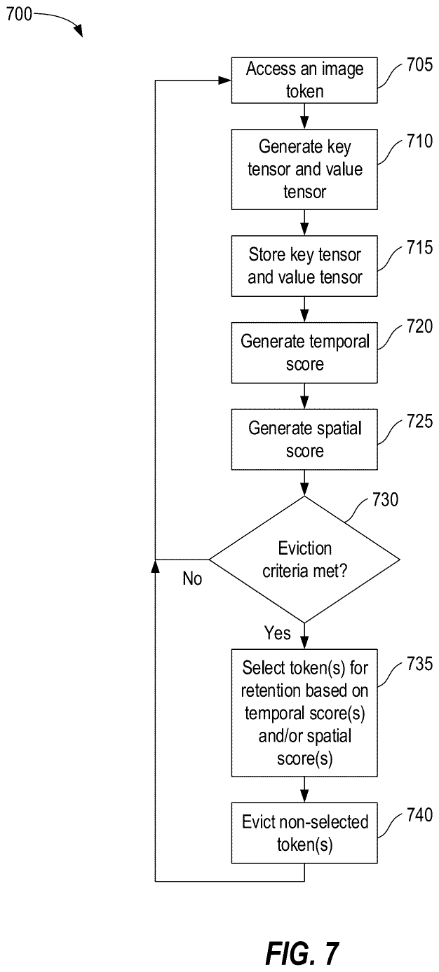

FIG. 7 is a flow diagram depicting an example method 700 for efficient cache management using spatial and temporal scoring, according to some aspects of the present disclosure. In some aspects, the method 700 is performed by a machine learning system, such as the machine learning system 110 of FIG. 1.

At block 705, the machine learning system accesses an image token. As used herein, “accessing” data may generally include receiving, requesting, retrieving, generating, or otherwise gaining access to the data. For example, as discussed above, the machine learning system may generate the image token based on an input image, or may receive the image token. As discussed above, the image token generally corresponds to a patch of pixels (or features generated therefrom) from an input image. In some aspects, as discussed above, the image is one of a sequence of images (e.g., in the input video 105 of FIG. 1 and/or the set of images 205 of FIG. 2). That is, the image token may be one token in a sequence of tokens from one image of a sequence of images (e.g., in a video stream). In some aspects, the image token is accessed as input to a generative machine learning model (e.g., to be ingested in order to generate a model output in the future when a query is received).

At block 710, the machine learning system generates a key tensor and a value tensor for the accessed image token. In some aspects, as discussed above, the key tensor and the value tensor may be generated by processing (e.g., multiplying) the image token using sets of learned weights (e.g., a set of key weights and a set of value weights), where the weights have values learned during training of the generative machine learning model. In some aspects, as discussed above, the key tensor and the value tensor may collectively be referred to as “intermediate data,” and may be generated as part of one or more attention operations of the machine learning model. Although not depicted in the illustrated example, in some aspects, the machine learning system may also generate other intermediate data, such as a query tensor.

At block 715, the machine learning system stores the key tensor and the value tensor in a memory (e.g., a KV cache). As discussed above, storing the key tensor and the value tensor in the memory can allow the data to be efficiently used during the generation phase (e.g., when a query is received, or the model is otherwise prompted to generate output based on the ingested images).

At block 720, the machine learning system generates a temporal score for the image token. In some aspects, as discussed above, the machine learning system may generate the temporal score based on the key tensor of the token (generated at block 710) and a set of key tensors of one or more corresponding tokens (e.g., tokens at the same spatial index) in one or more other images in the sequence of images (e.g., one or more prior images, such as the immediately prior image(s) in the sequence). For example, as discussed above, the machine learning system may compute a respective similarity score with respect to each respective prior token, and then aggregate these similarity scores (e.g., by summing or averaging the similarity scores). In some aspects, the machine learning system may use Equations 1, 2 and/or 3, discussed above with reference to FIG. 4, to generate the temporal score of the image token.

At block 725, the machine learning system generates a spatial score of the image token. In some aspects, as discussed above, the machine learning system may generate the spatial score based on the value norm (e.g., the norm of the value tensor) of the token. In some aspects, the spatial score may be generated by pooling the value norm of the image token (accessed at block 705) with a set of value norms generated for a set of other tokens having adjacent spatial indices (relative to the image token accessed at block 705) in the same image. For example, as discussed above, the machine learning system may use maximum pooling, average pooling, and the like. In some aspects, the machine learning system may generate the spatial score using the techniques discussed above with reference to FIG. 5.

At block 730, the machine learning system determines whether one or more eviction criteria are met with respect to the memory (e.g., the cache) of the model. Generally, the eviction criteria may include a variety of considerations. For example in some aspects, the machine learning system may determine whether the memory has reached a defined fullness (e.g., a defined number of tensors and/or data for a defined number of tokens being stored in the memory). In some aspects, the machine learning system may determine whether a defined number of input images and/or tokens therefrom have been ingested.

If the eviction criteria are not satisfied, the method 700 returns to block 705 to begin ingesting the next image token in the sequence. If the criteria are satisfied, the method 700 continues to block 735. Although the illustrated example depicts generation of the temporal score (at block 720) and the spatial score (at block 725) during the ingestion phase and prior to evaluating the eviction criteria (at block 730) for conceptual clarity, in some aspects, the machine learning system may instead generate the temporal score and/or spatial score of each token after determining that the eviction criteria are satisfied (e.g., during the eviction and/or compression phase of the iteration).

At block 735, the machine learning system selects one or more tokens for retention based on the temporal score(s) and/or the spatial score(s) of the tokens having data stored in the memory. For example, as discussed above, the machine learning system may first select a first set of tokens (e.g., a first set of key tensors and/or value tensors) to be retained based on the temporal scores (e.g., selecting the tokens with the highest K temporal scores). The machine learning system may then select a second set of tokens (e.g., the remaining tokens to be retained, where the number of remaining tokens to be retained may be determined based on the overall cache budget and the number of tokens retained based on the temporal scores) based on the spatial scores (e.g., selecting the tokens with the highest M spatial scores).

In some aspects, the machine learning system selects the second set of tokens (based on the spatial scores) from the pool of tokens remaining in the memory after the first set of tokens (selected based on the temporal scores) have been selected. That is, the machine learning system may ensure that each token having a high temporal score is retained, followed by selecting additional tokens to retain based on their spatial scores.

At block 740, the machine learning system evicts the set of non-selected tokens. That is, the machine learning system may evict, delete, remove, or otherwise mark as “evicted,” the intermediate data (e.g., key tensors and/or value tensors) for any tokens that were not selected for the first set of retained tokens (based on the temporal scores) or the second set of retained tokens (based on the spatial scores). In some aspects, as discussed above, the machine learning system may optionally compress the remaining data in the memory, such as by consolidating the remaining tensors to adjacent memory addresses.

The method 700 then returns to block 705 to begin a new iteration of ingesting image frames. As discussed above, this process may continue until one or more termination criteria are met, such as when the model is prompted to stop ingesting the video and begin generation of an output (e.g., based on a provided query such as “how many trees were in the front yard of the yellow house?”).

### Example Method for Cache Management

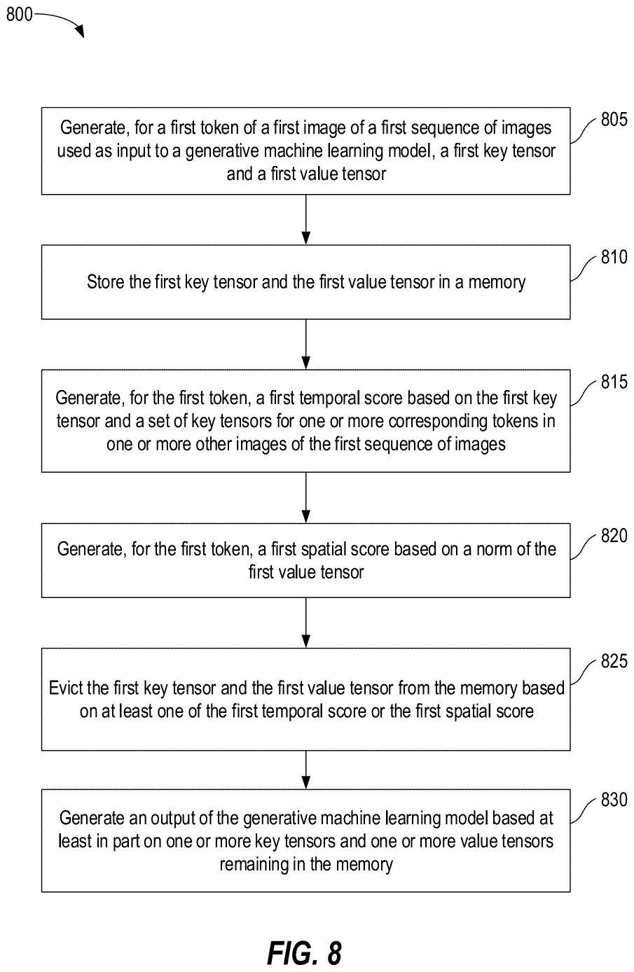

FIG. 8 is a flow diagram depicting an example method 800 for cache management, according to some aspects of the present disclosure. In some aspects, the method 800 is performed by a machine learning system, such as the machine learning system 110 of FIG. 1.

At block 805, a first key tensor and a first value tensor are generated for a first token of a first image of a first sequence of images (e.g., the set of images 205 of FIG. 2) used as input to a generative machine learning model.

At block 810, the first key tensor and the first value tensor are stored in a memory (e.g., the cache 210 of FIG. 2).

At block 815, a first temporal score (e.g., the temporal score 212 of FIG. 2) is generated, for the first token (e.g., the token 415A of FIG. 4), based on the first key tensor and a set of key tensors for one or more corresponding tokens (e.g., the tokens 415B-D of FIG. 4) in one or more other images (e.g., the images 405B-D of FIG. 4) of the first sequence of images.

At block 820, a first spatial score is generated, for the first token, based on a norm of the first value tensor.

At block 825, the first key tensor and the first value tensor are evicted from the memory based on at least one of the first temporal score or the first spatial score.

At block 830, an output of the generative machine learning model (e.g., the output 115 of FIG. 1) is generated based at least in part on one or more key tensors and one or more value tensors remaining in the memory.

In some aspects, generating the first temporal score comprises generating, for each respective key tensor of the set of key tensors, a respective similarity score with respect to the first key tensor and generating the first temporal score based on aggregating the respective similarity scores, wherein the first temporal score is inversely related to the respective similarity scores.

In some aspects, the one or more other images comprise a set of images immediately prior to the first image in the first sequence of images.

In some aspects, the one or more corresponding tokens comprise tokens, in the one or more other images, at a matching spatial index of the first token.

In some aspects, generating the first spatial score comprises generating a value norm of the first value tensor based on computing a norm of the first value tensor and generating the first spatial score based on pooling the first value norm with a set of value norms for one or more adjacent tokens (e.g., the tokens 515 of FIG. 5).

In some aspects, the one or more adjacent tokens comprise a set of tokens, in the first image, at spatial indices immediately adjacent to a spatial index of the first token.

In some aspects, evicting the first key tensor and the first value tensor from the memory comprises selecting a first subset of key tensors, stored in the memory, for retention based on temporal scores corresponding to the first subset of key tensors and selecting a second subset of key tensors, stored in the memory, for retention based on spatial scores corresponding to the second subset of key tensors, wherein the first key tensor is not in the first or second subset of key tensors.

In some aspects, the method 800 further includes generating, for a second token of the first image, a second key tensor, a second value tensor, a second temporal score, and a second spatial score and determining to retain the second key tensor and the second value tensor in the memory based on at least one of the second temporal score or the second spatial score.

In some aspects, the method 800 further includes accessing a second sequence of images (e.g., during the second iteration 302B of FIG. 3) as input to the generative machine learning model, generating, for a third token of a second image of the second sequence of images, a third temporal score and a third spatial score, and subsequent to determining to retain the second key tensor and the second value tensor based on at least one of the second temporal score or the second spatial score, evicting the second key tensor and the second value tensor from the memory based on at least one of the third temporal score or the third spatial score.

### Example Processing System for Machine Learning

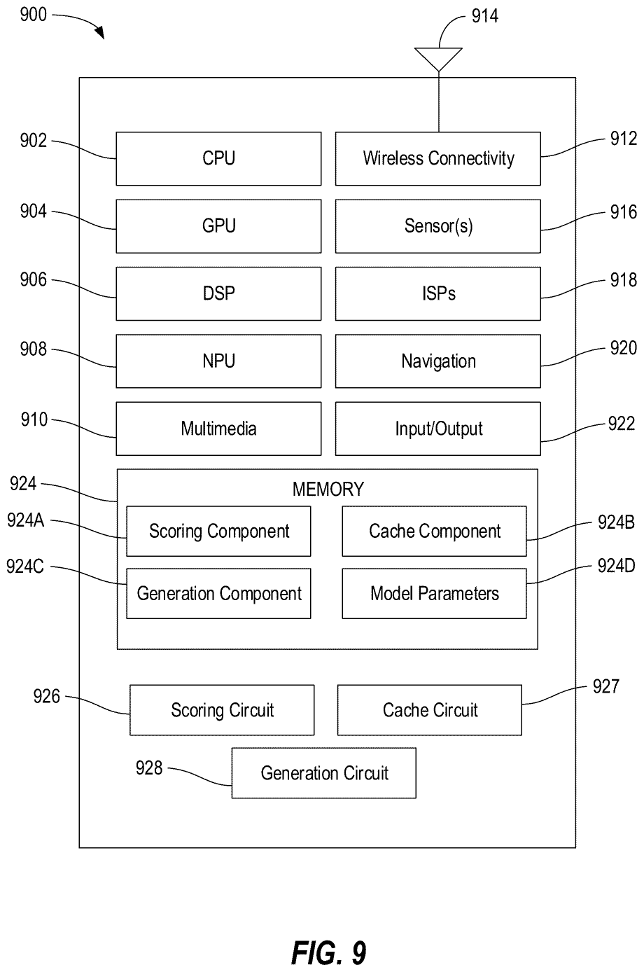

FIG. 9 depicts an example processing system 900 configured to perform various aspects of the present disclosure, including, for example, the techniques and methods described with respect to FIGS. 1-8. In some aspects, the processing system 900 may correspond to a machine learning system. For example, the processing system 900 may correspond to the machine learning system 110 of FIG. 1 and/or the machine learning system discussed above with reference to FIGS. 2-8. Although depicted as a single system for conceptual clarity, in some aspects, as discussed above, the components described below with respect to the processing system 900 may be distributed across any number of devices or systems. In some aspects, the processing system 900 may be part of a mobile device.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., a partition of a memory 924).

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as the NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 912 is further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes a memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a scoring component 924A, a cache component 924B, and a generation component 924C. Although not depicted in the illustrated example, the memory 924 may also include other components, such as a training component used to train or update machine learning model(s). Though depicted as discrete components for conceptual clarity in FIG. 9, the illustrated components (and others not depicted) may be collectively or individually implemented in various aspects.

Further, in the illustrated example, the memory 924 also includes model parameters 924D (e.g., parameters of one or more machine learning models, such as a generative machine learning model (e.g., an LVM)). Although not depicted in the illustrated example, in some aspects, the memory 924 may include other data such as a training data for the machine learning model(s), and the like.

The processing system 900 further comprises a scoring circuit 926, a cache circuit 927, and a generation circuit 928. The depicted circuits, and others not depicted (such as an inferencing circuit), may be configured to perform various aspects of the techniques described herein.

The scoring component 924A and/or the scoring circuit 926 (which may correspond to the scoring component 120 of FIG. 1) may be used to generate temporal scores and/or spatial scores for tokens stored in a machine learning model cache, as discussed above. For example, the scoring component 924A and/or the scoring circuit 926 may use Equations 1-3 to generate the temporal scores based on the similarity between the value tensor of each given token and the value tensor(s) of one or more corresponding tokens in one or more prior frames, and/or may generate the spatial scores based on the value norm(s) of each token.

The cache component 924B and/or the cache circuit 927 may be used to selectively evict tokens from the cache based on the temporal and/or spatial scores, as discussed above. For example, the cache component 924B and/or the cache circuit 927 may, when the cache is full and/or at the end of each ingestion iteration, evict the data for tokens having a low temporal score and/or low spatial score, as discussed above.

The generation component 924C and/or the generation circuit 928 may be used to generate intermediate tensors (e.g., keys and values) and/or machine learning model output (e.g., the output 115 of FIG. 1), as discussed above. For example, the generation component 924C and/or the generation circuit 928 may evaluate an input query or prompt (e.g., a natural language instruction or question) conditioned on the data in the cache (e.g., the data from the input video stream) to generate the output.

Though depicted as separate components and circuits for clarity in FIG. 9, the scoring circuit 926, the cache circuit 927, and the generation circuit 928 may collectively or individually be implemented in other processing devices of the processing system 900, such as within the CPU 902, the GPU 904, the DSP 906, the NPU 908, and the like.

Generally, the processing system 900 and/or components thereof may be configured to perform the methods described herein.

Notably, in other aspects, components of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, components of the processing system 900 may be distributed between multiple devices.

### Example Clauses

Implementation examples are described in the following numbered clauses:

Clause 1: A method, comprising: generating, for a first token of a first image of a first sequence of images used as input to a generative machine learning model, a first key tensor and a first value tensor; storing the first key tensor and the first value tensor in a memory; generating, for the first token, a first temporal score based on the first key tensor and a set of key tensors for one or more corresponding tokens in one or more other images of the first sequence of images; generating, for the first token, a first spatial score based on a norm of the first value tensor; evicting the first key tensor and the first value tensor from the memory based on at least one of the first temporal score or the first spatial score; and generating an output of the generative machine learning model based at least in part on one or more key tensors and one or more value tensors remaining in the memory.

Clause 2: A method according to Clause 1, wherein generating the first temporal score comprises: generating, for each respective key tensor of the set of key tensors, a respective similarity score with respect to the first key tensor; and generating the first temporal score based on aggregating the respective similarity scores, wherein the first temporal score is inversely related to the respective similarity scores.

Clause 3: A method according to Clause 1-2, wherein the one or more other images comprise a set of images immediately prior to the first image in the first sequence of images.

Clause 4: A method according to any of Clauses 1-3, wherein the one or more corresponding tokens comprise tokens, in the one or more other images, at a matching spatial index of the first token.

Clause 5: A method according to any of Clauses 1-4, wherein generating the first spatial score comprises: generating a value norm of the first value tensor based on computing a norm of the first value tensor; and generating the first spatial score based on pooling the first value norm with a set of value norms for one or more adjacent tokens.

Clause 6: A method according to Clause 5, wherein the one or more adjacent tokens comprise a set of tokens, in the first image, at spatial indices immediately adjacent to a spatial index of the first token.

Clause 7: A method according to any of Clauses 1-6, wherein evicting the first key tensor and the first value tensor from the memory comprises: selecting a first subset of key tensors, stored in the memory, for retention based on temporal scores corresponding to the first subset of key tensors; and selecting a second subset of key tensors, stored in the memory, for retention based on spatial scores corresponding to the second subset of key tensors, wherein the first key tensor is not in the first or second subset of key tensors.

Clause 8: A method according to any of Clauses 1-7, further comprising: generating, for a second token of the first image, a second key tensor, a second value tensor, a second temporal score, and a second spatial score; and determining to retain the second key tensor and the second value tensor in the memory based on at least one of the second temporal score or the second spatial score.

Clause 9: A method according to Clause 8, further comprising: accessing a second sequence of images as input to the generative machine learning model; generating, for a third token of a second image of the second sequence of images, a third temporal score and a third spatial score; and subsequent to determining to retain the second key tensor and the second value tensor based on at least one of the second temporal score or the second spatial score, evicting the second key tensor and the second value tensor from the memory based on at least one of the third temporal score or the third spatial score.

Clause 10: A processing system comprising: one or more memories storing processor-executable instructions; and one or more processors coupled to the one or more memories and configured to execute the processor-executable instructions and cause the processing system to perform a method in accordance with any of Clauses 1-9.

Clause 11: A mobile device comprising the processing system of Clause 10.

Clause 12: A processing system comprising means for performing a method in accordance with any of Clauses 1-9.

Clause 13: A non-transitory computer-readable medium comprising computer-executable instructions that, when executed by one or more processors of a processing system, cause the processing system to perform a method in accordance with any of Clauses 1-9.

Clause 14: A computer program product embodied on a computer-readable storage medium comprising code for performing a method in accordance with any of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processing system for machine learning comprising:
one or more memories comprising processor-executable instructions; and
one or more processors coupled to the one or more memories and configured to execute the processor-executable instructions and cause the processing system to:
generate, for a first token of a first image of a first sequence of images used as input to a generative machine learning model, a first key tensor and a first value tensor;
store the first key tensor and the first value tensor in a memory;
generate, for the first token, a first temporal score based on the first key tensor and a set of key tensors for one or more corresponding tokens in one or more other images of the first sequence of images;
generate, for the first token, a first spatial score based on a norm of the first value tensor;
evict the first key tensor and the first value tensor from the memory based on at least one of the first temporal score or the first spatial score; and
generate an output of the generative machine learning model based at least in part on one or more key tensors and one or more value tensors remaining in the memory;
wherein, to generate the first temporal score, the one or more processors are configured to execute the processor-executable instructions and cause the processing system to:
generate, for each respective key tensor of the set of key tensors, a respective similarity score with respect to the first key tensor; and
generate the first temporal score based on aggregating the respective similarity scores, wherein the first temporal score is inversely related to the respective similarity scores.

2. (canceled)

3. The processing system of claim 1, wherein the one or more other images comprise a set of images immediately prior to and separate from the first image in the first sequence of images.

4. The processing system of claim 1, wherein the one or more corresponding tokens comprise tokens, in the one or more other images, at a matching spatial index of the first token.

5. The processing system of claim 1, wherein, to generate the first spatial score, the one or more processors are configured to execute the processor-executable instructions and cause the processing system to:
generate a value norm of the first value tensor based on computing a norm of the first value tensor; and
generate the first spatial score based on pooling the value norm with a set of value norms for one or more adjacent tokens.

6. The processing system of claim 5, wherein the one or more adjacent tokens comprise a set of tokens, in the first image, at spatial indices immediately adjacent to a spatial index of the first token.

7. The processing system of claim 1, wherein, to evict the first key tensor and the first value tensor from the memory, the one or more processors are configured to execute the processor-executable instructions and cause the processing system to:
select a first subset of key tensors, stored in the memory, for retention based on temporal scores corresponding to the first subset of key tensors; and
select a second subset of key tensors, stored in the memory, for retention based on spatial scores corresponding to the second subset of key tensors, wherein the first key tensor is not in the first or second subset of key tensors.

8. The processing system of claim 1, wherein the one or more processors are configured to execute the processor-executable instructions and further cause the processing system to:
generate, for a second token of the first image, a second key tensor, a second value tensor, a second temporal score, and a second spatial score; and
determine to retain the second key tensor and the second value tensor in the memory based on at least one of the second temporal score or the second spatial score.

9. The processing system of claim 8, wherein the one or more processors are configured to execute the processor-executable instructions and further cause the processing system to:
access a second sequence of images as input to the generative machine learning model;
generate, for a third token of a second image of the second sequence of images, a third temporal score and a third spatial score; and
subsequent to determining to retain the second key tensor and the second value tensor based on at least one of the second temporal score or the second spatial score, evict the second key tensor and the second value tensor from the memory based on at least one of the third temporal score or the third spatial score.

10. A mobile device comprising the processing system of claim 1.

11. A processor-implemented method for generative machine learning, comprising:
generating, for a first token of a first image of a first sequence of images used as input to a generative machine learning model, a first key tensor and a first value tensor;
storing the first key tensor and the first value tensor in a memory;
generating, for the first token, a first temporal score based on the first key tensor and a set of key tensors for one or more corresponding tokens in one or more other images of the first sequence of images;
generating, for the first token, a first spatial score based on a norm of the first value tensor;
evicting the first key tensor and the first value tensor from the memory based on at least one of the first temporal score or the first spatial score; and
generating an output of the generative machine learning model based at least in part on one or more key tensors and one or more value tensors remaining in the memory;
wherein generating the first temporal score comprises:
generating, for each respective key tensor of the set of key tensors, a respective similarity score with respect to the first key tensor; and
generating the first temporal score based on aggregating the respective similarity scores, wherein the first temporal score is inversely related to the respective similarity scores.

12. (canceled)

13. The processor-implemented method of claim 11, wherein the one or more other images comprise a set of images immediately prior to and separate from the first image in the first sequence of images.

14. The processor-implemented method of claim 11, wherein the one or more corresponding tokens comprise tokens, in the one or more other images, at a matching spatial index of the first token.

15. The processor-implemented method of claim 11, wherein generating the first spatial score comprises:
generating a value norm of the first value tensor based on computing a norm of the first value tensor; and
generating the first spatial score based on pooling the value norm with a set of value norms for one or more adjacent tokens.

16. The processor-implemented method of claim 15, wherein the one or more adjacent tokens comprise a set of tokens, in the first image, at spatial indices immediately adjacent to a spatial index of the first token.

17. The processor-implemented method of claim 11, wherein evicting the first key tensor and the first value tensor from the memory comprises:
selecting a first subset of key tensors, stored in the memory, for retention based on temporal scores corresponding to the first subset of key tensors; and
selecting a second subset of key tensors, stored in the memory, for retention based on spatial scores corresponding to the second subset of key tensors, wherein the first key tensor is not in the first or second subset of key tensors.

18. The processor-implemented method of claim 11, further comprising:
generating, for a second token of the first image, a second key tensor, a second value tensor, a second temporal score, and a second spatial score; and
determining to retain the second key tensor and the second value tensor in the memory based on at least one of the second temporal score or the second spatial score.

19. The processor-implemented method of claim 18, further comprising:
accessing a second sequence of images as input to the generative machine learning model;
generating, for a third token of a second image of the second sequence of images, a third temporal score and a third spatial score; and
subsequent to determining to retain the second key tensor and the second value tensor based on at least one of the second temporal score or the second spatial score, evicting the second key tensor and the second value tensor from the memory based on at least one of the third temporal score or the third spatial score.

20. A processing system, comprising:
means for generating, for a token of an image of a sequence of images used as input to a generative machine learning model, a key tensor and a value tensor;
means for storing the key tensor and the value tensor;
means for generating, for the token, a temporal score based on the key tensor and a set of key tensors for one or more corresponding tokens in one or more other images of the sequence of images;
means for generating, for the token, a spatial score based on a norm of the value tensor;
means for evicting the key tensor and the value tensor from the means for storing based on at least one of the temporal score or the spatial score; and
means for generating an output of the generative machine learning model based at least in part on one or more key tensors and one or more value tensors remaining in the means for storing;
wherein mean for generating the temporal score comprises:
means for generating, for each respective key tensor of the set of key tensors, a respective similarity score with respect to the key tensor; and
means for generating the temporal score based on aggregating the respective similarity scores, wherein the temporal score is inversely related to the respective similarity scores.
